(19) United States
(12) Patent Application Publication
(10) Pub. No.: US 2025/0233696 A1
(43) Pub. Date: Jul. 17, 2025

(54) TRANSMITTING FEEDBACK USING SLOTS BASED AT LEAST IN PART ON A SET OF TIMELINES

(71) Applicant: QUALCOMM Incorporated, San Diego, CA (US)

(72) Inventors: Shaozhen GUO, Beijing (CN); Chih-Hao LIU, San Diego, CA (US); Changlong XU, Beijing (CN); Jing SUN, San Diego, CA (US); Xiaoxia ZHANG, San Diego, CA (US); Luanxia YANG, Beijing (CN); Siyi CHEN, Beijing (CN); Hao XU, Beijing (CN)

(21) Appl. No.: 18/853,543

(22) PCT Filed: May 27, 2022
(86) PCT No.: PCT/CN2022/095686

§ 371 Date: Oct. 2, 2024

(51) Int. Cl. H04L 1/1829; H04L 1/1812; H04W 72/25

(52) U.S. Cl. CPC H04L 1/1854; H04L 1/1812; H04W 72/25

(57) ABSTRACT

Various aspects of the present disclosure generally relate to wireless communication. In some aspects, a first user equipment (UE) may receive, from a second UE, a sidelink transmission associated with a cast type. The first UE may transmit, to the second UE, hybrid automatic repeat request (HARQ) feedback based at least in part on the sidelink transmission, wherein slots used for transmitting the HARQ feedback are based at least in part on a set of HARQ timelines associated with the cast type, and wherein the set of HARQ timelines is included in multiple sets of HARQ timelines configured for sidelink. Numerous other aspects are described.

### FIELD OF THE DISCLOSURE

Aspects of the present disclosure generally relate to wireless communication and to techniques and apparatuses for transmitting feedback using slots based at least in part on a set of timelines.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a first user equipment (UE) includes a memory and one or more processors, coupled to the memory, configured to: receive, from a second UE, a sidelink transmission associated with a cast type; and transmit, to the second UE, hybrid automatic repeat request (HARQ) feedback based at least in part on the sidelink transmission, wherein slots used for transmitting the HARQ feedback are based at least in part on a set of HARQ timelines associated with the cast type, and wherein the set of HARQ timelines is included in multiple sets of HARQ timelines configured for sidelink.

In some implementations, an apparatus for wireless communication at a first UE includes a memory and one or more processors, coupled to the memory, configured to: receive, from a second UE, sidelink control information (SCI); receive, from the second UE, a sidelink transmission; and transmit, to the second UE, HARQ feedback based at least in part on the sidelink transmission, wherein slots used for transmitting the HARQ feedback are based at least in part on a subset of HARQ timelines indicated by the SCI, and wherein the subset of HARQ timelines is included in multiple HARQ timelines configured for sidelink.

In some implementations, a method of wireless communication performed by a first UE includes receiving, from a second UE, a sidelink transmission associated with a cast type; and transmitting, to the second UE, HARQ feedback based at least in part on the sidelink transmission, wherein slots used for transmitting the HARQ feedback are based at least in part on a set of HARQ timelines associated with the cast type, and wherein the set of HARQ timelines is included in multiple sets of HARQ timelines configured for sidelink.

In some implementations, a method of wireless communication performed by a first UE includes receiving, from a second UE, SCI; receiving, from the second UE, a sidelink transmission; and transmitting, to the second UE, HARQ feedback based at least in part on the sidelink transmission, wherein slots used for transmitting the HARQ feedback are based at least in part on a subset of HARQ timelines indicated by the SCI, and wherein the subset of HARQ timelines is included in multiple HARQ timelines configured for sidelink.

In some implementations, a non-transitory computer-readable medium storing a set of instructions for wireless communication includes one or more instructions that, when executed by one or more processors of a first UE, cause the first UE to: receive, from a second UE, a sidelink transmission associated with a cast type; and transmit, to the second UE, HARQ feedback based at least in part on the sidelink transmission, wherein slots used for transmitting the HARQ feedback are based at least in part on a set of HARQ timelines associated with the cast type, and wherein the set of HARQ timelines is included in multiple sets of HARQ timelines configured for sidelink.

In some implementations, a non-transitory computer-readable medium storing a set of instructions for wireless communication includes one or more instructions that, when executed by one or more processors of a first UE, cause the first UE to: receive, from a second UE, SCI; receive, from the second UE, a sidelink transmission; and transmit, to the second UE, HARQ feedback based at least in part on the sidelink transmission, wherein slots used for transmitting the HARQ feedback are based at least in part on a subset of HARQ timelines indicated by the SCI, and wherein the subset of HARQ timelines is included in multiple HARQ timelines configured for sidelink.

In some implementations, a first apparatus for wireless communication includes means for receiving, from a second apparatus, a sidelink transmission associated with a cast type; and means for transmitting, to the second apparatus, HARQ feedback based at least in part on the sidelink transmission, wherein slots used for transmitting the HARQ feedback are based at least in part on a set of HARQ timelines associated with the cast type, and wherein the set of HARQ timelines is included in multiple sets of HARQ timelines configured for sidelink.

In some implementations, a first apparatus for wireless communication includes means for receiving, from a second apparatus, SCI; means for receiving, from the second apparatus, a sidelink transmission; and means for transmitting, to the second apparatus, HARQ feedback based at least in part on the sidelink transmission, wherein slots used for transmitting the HARQ feedback are based at least in part on a subset of HARQ timelines indicated by the SCI, and wherein the subset of HARQ timelines is included in multiple HARQ timelines configured for sidelink.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink transmissions, in accordance with the present disclosure.

FIG. 4 is a diagram illustrating an example of multiple time domain physical sidelink feedback channel (PSFCH) opportunities, in accordance with the present disclosure.

FIGS. 5-12 are diagrams illustrating examples associated with transmitting feedback using slots based at least in part on a set of timelines, in accordance with the present disclosure.

FIGS. 13-14 are diagrams illustrating example processes associated with transmitting feedback using slots based at least in part on a set of timelines, in accordance with the present disclosure.

FIG. 15 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

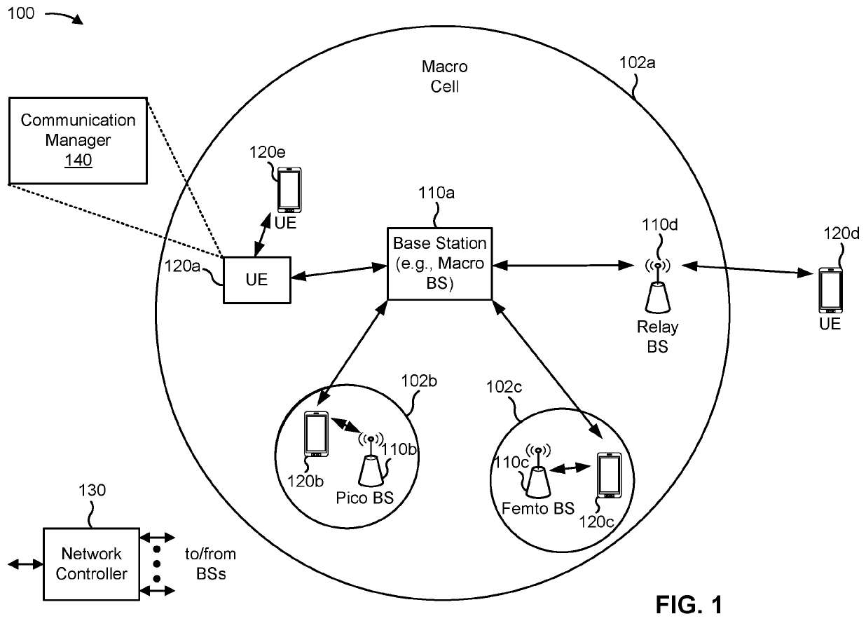

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., UE 120a) may include a communication manager 140. As described in more detail elsewhere herein, the communication manager 140 may receive, from a second UE (e.g., UE 120e), a sidelink transmission associated with a cast type; and transmit, to the second UE, hybrid automatic repeat request (HARQ) feedback based at least in part on the sidelink transmission, wherein slots used for transmitting the HARQ feedback are based at least in part on a set of HARQ timelines associated with the cast type, and wherein the set of HARQ timelines is included in multiple sets of HARQ timelines configured for sidelink. Additionally, or alternatively, the communication manager 140 may perform one or more other operations described herein.

In some aspects, the communication manager 140 may receive, from a second UE, sidelink control information (SCI); receive, from the second UE, a sidelink transmission; and transmit, to the second UE, HARQ feedback based at least in part on the sidelink transmission, wherein slots used for transmitting the HARQ feedback are based at least in part on a subset of HARQ timelines indicated by the SCI, and wherein the subset of HARQ timelines is included in multiple HARQ timelines configured for sidelink. Additionally, or alternatively, the communication manager 140 may perform one or more other operations described herein.

As indicated above, FIG. 1 is provided as an example. Other examples may differ from what is described with regard to FIG. 1.

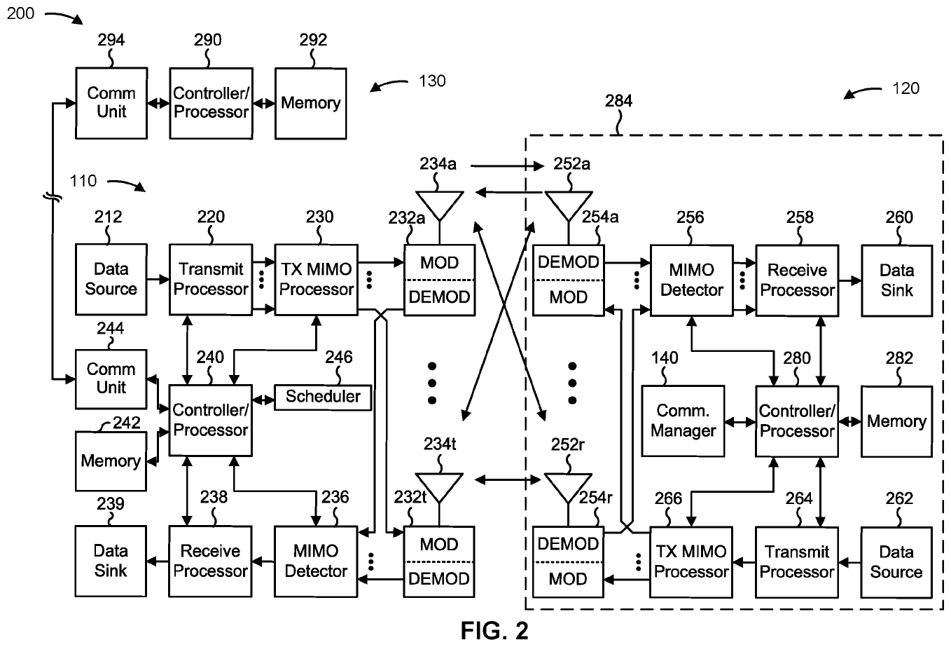

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

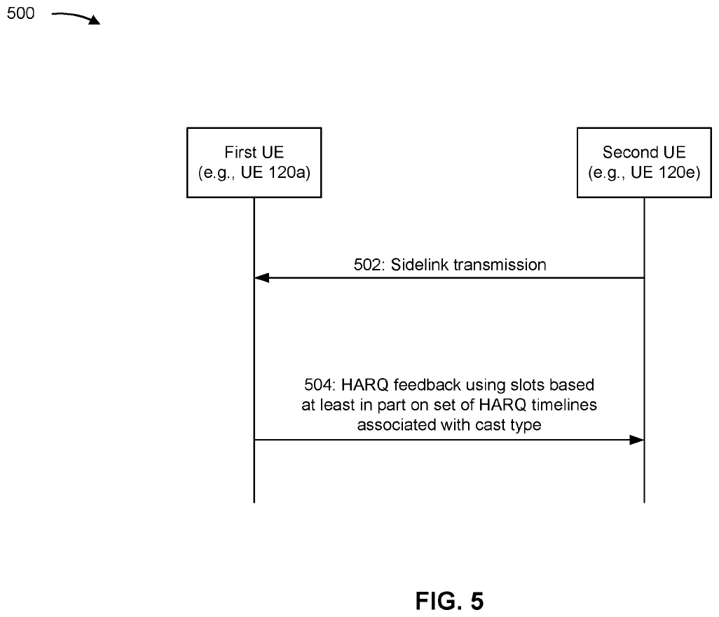

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-15).

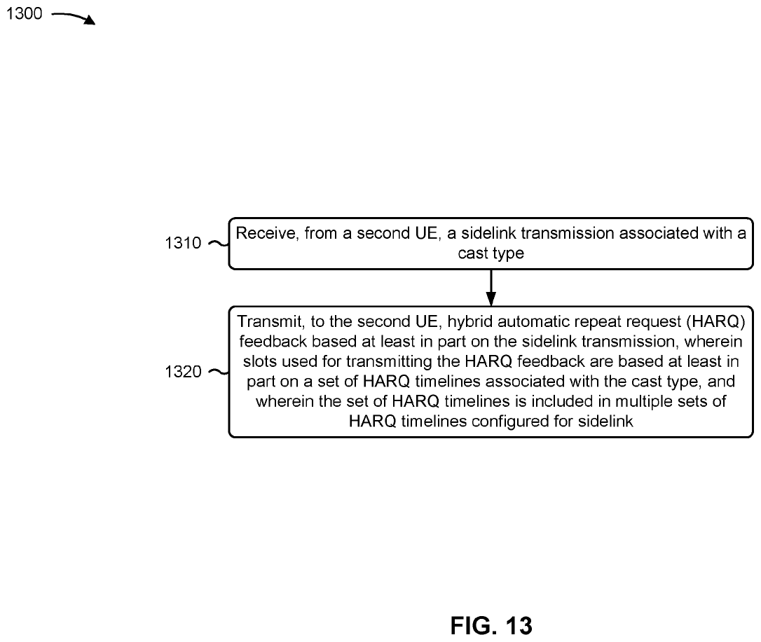

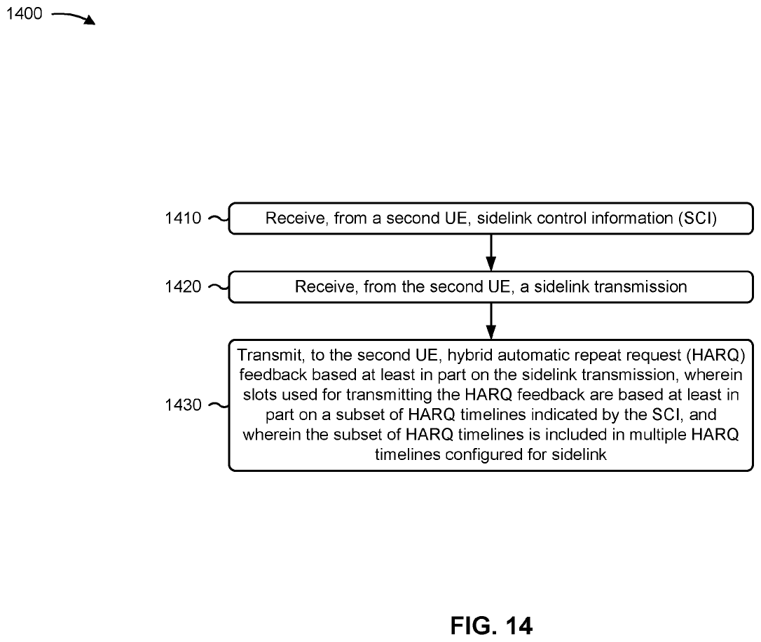

The controller/processor 240 of the network node 110, the controller/processor 280 of the UE 120, and/or any other component(s) of FIG. 2 may perform one or more techniques associated with transmitting feedback using slots based at least in part on a set of timelines, as described in more detail elsewhere herein. For example, the controller/processor 240 of the network node 110, the controller/processor 280 of the UE 120, and/or any other component(s) of FIG. 2 may perform or direct operations of, for example, process 1300 of FIG. 13, process 1400 of FIG. 14, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, a first UE (e.g., UE 120a) includes means for receiving, from a second UE (e.g., UE 120e), a sidelink transmission associated with a cast type; and/or means for transmitting, to the second UE, HARQ feedback based at least in part on the sidelink transmission, wherein slots used for transmitting the HARQ feedback are based at least in part on a set of HARQ timelines associated with the cast type, and wherein the set of HARQ timelines is included in multiple sets of HARQ timelines configured for sidelink. In some aspects, the first UE includes means for receiving, from a second UE, SCI; means for receiving, from the second UE, a sidelink transmission; and/or means for transmitting, to the second UE, HARQ feedback based at least in part on the sidelink transmission, wherein slots used for transmitting the HARQ feedback are based at least in part on a subset of HARQ timelines indicated by the SCI, and wherein the subset of HARQ timelines is included in multiple HARQ timelines configured for sidelink. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

An NR V2X/sidelink design may target a deployment in a licensed spectrum, which may involve sharing a spectrum in a licensed cellular band, or using a dedicated spectrum for an intelligent transportation system (ITS). Cellular V2X communications may be deployed in an unlicensed spectrum, since a licensed/ITS spectrum for NR V2X may not be guaranteed in some regions. However, the unlicensed spectrum may be shared by other technologies (e.g., Wi-Fi), and access to the unlicensed spectrum may be subject to regulatory requirements. One regulatory requirement may include listen-before-talk (LBT), in which a device needs to perform a sensing (e.g., listen) before transmitting (e.g., talk). In LBT, the device may measure an amount of energy in the band, and the device may be able to transmit using the band when the energy satisfies a threshold (e.g., the energy is below the threshold). The LBT may include a category (CAT) 2 LBT, which may be an LBT without random back-off, or a CAT 4 LBT, which may be an LBT with random back-off with a contention window of variable size.

An NR V2X/sidelink HARQ feedback mechanism may be used for a licensed/ITS spectrum. A first UE may transmit sidelink data over a sidelink channel. A second UE may transmit, to the second UE, HARQ feedback depending on whether the sidelink data is successfully decoded by the second UE. The HARQ feedback may be HARQ acknowledgement (ACK) or negative acknowledgement (NACK) feedback. The HARQ feedback may be transmitted via a physical sidelink feedback channel (PSFCH) using a (pre)-configured PSFCH resource, which may occur every N slots (N=0,1,2,4). The PSFCH resource used for transmitting HARQ feedback corresponding to a physical sidelink shared channel (PSSCH) may be based at least in part on a time/frequency location of the HARQ feedback transmission, a transmitter UE identifier (ID), and/or a receiver UE ID when the HARQ feedback is for an ACK/NACK-based groupcast communication (e.g., groupcast option 2). Each HARQ feedback may be transmitted using one physical resource block (PRB) and two OFDM symbols in the PSFCH resource.

Multiple PSFCH resources may be configured that correspond to a PSSCH transmission. Multiple resources may be used for groupcast HARQ feedback, so different Rx UEs in the group may transmit HARQ feedback in different PSFCH resources. Multiple Tx UEs may transmit sidelink data is same resources, thereby causing sidelink data collisions, in which case multiple HARQ resource mappings may alleviate HARQ collisions.

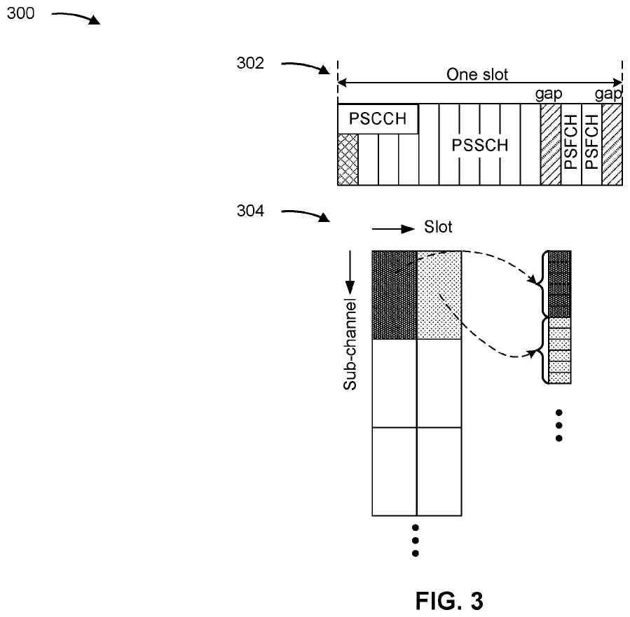

FIG. 3 is a diagram illustrating an example 300 of sidelink transmissions, in accordance with the present disclosure.

As shown by reference number 302, one slot may include physical sidelink control channel (PSCCH) resources, PSSCH resources, and PSFCH resources. Sidelink data transmissions may occur using the PSCCH resources or the PSSCH resources. HARQ feedback may be transmitted using the PSFCH resources. As shown by reference number 304, a PSSCH transmission may correspond to multiple configured PSFCH resources.

As indicated above, FIG. 3 is provided as an example. Other examples may differ from what is described with regard to FIG. 3.

Multiple time domain PSFCH opportunities via different HARQ timelines may be employed, which may reduce an LBT failure probability for HARQ feedback transmissions for sidelink communications. Multiple HARQ timelines may be defined so that one PSSCH has more than one PSFCH opportunity in the time domain. Additional time domain opportunities may be accommodated by using different PSFCH resource sets for different timelines, or alternatively, by splitting a current PSFCH resource set into static/orthogonal sub-sets (e.g., odd indices may be associated with a first HARQ timeline and even indices may be associated with a second HARQ timeline).

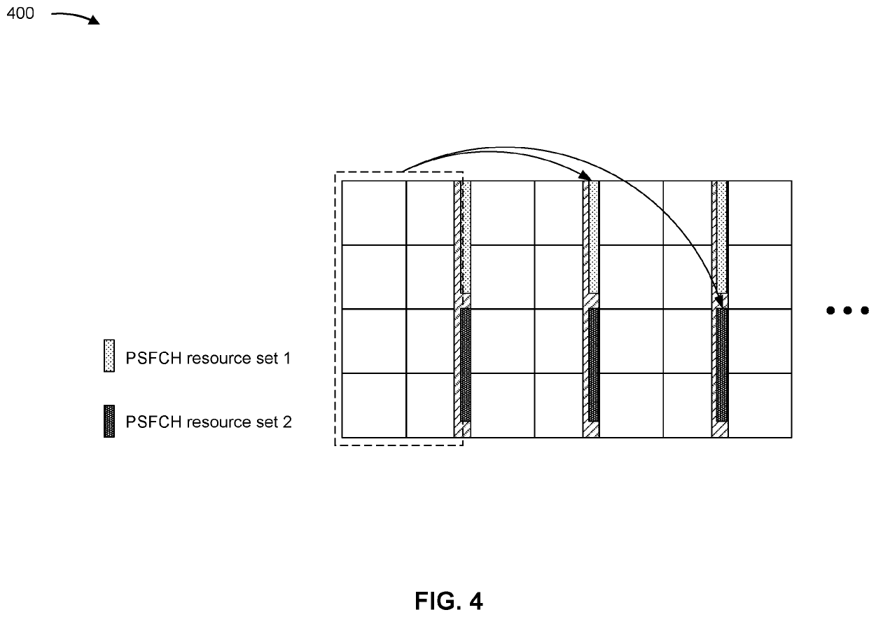

FIG. 4 is a diagram illustrating an example 400 of multiple time domain PSFCH opportunities, in accordance with the present disclosure.

As shown in FIG. 4, multiple HARQ timelines are configured so that a PSSCH may be associated with more than one PSFCH opportunity in a time domain. The PSSCH may be associated with a first PSFCH resource set, which may be associated with a first HARQ timeline of multiple HARQ timelines in the time domain. The PSSCH may be associated with a second PSFCH resource set, which may be associated with a second HARQ timelines of multiple HARQ timelines in the time domain.

As indicated above, FIG. 4 is provided as an example. Other examples may differ from what is described with regard to FIG. 4.

For each PSFCH reception occasion, from a quantity of PSFCH reception occasions, a UE (e.g., a Tx UE) may generate HARQ feedback information to report to a higher layer. For a unicast PSSCH transmission, the UE may report, to the higher layer, the same value received via a PSFCH (e.g., an ACK/NACK). When the PSFCH is not detected, the UE may treat the HARQ feedback information as a NACK. For groupcast option 2 (e.g., ACK/NACK-based feedback), the UE may report, to the higher layer, an ACK when a plurality of expected PSFCH resources (e.g., all expected PSFCH resources) from a group of Rx UEs are received and carry ACKs. The UE may report, to the higher layer, a NACK when at least one received PSFCH resource carries a NACK, or if some expected PSFCH resources are not detected. For groupcast option 1 (e.g., NACK-only feedback), the UE may report, to the higher layer, an ACK when the UE determines an absence of PSFCH reception for the PSFCH reception occasion, and otherwise, the UE may report a NACK to the higher layer. For unicast and groupcast option 2, when the PSFCH is not detected in the expected PSFCH resource, the UE may report the NACK to the higher layer. For groupcast option 1, when the PSFCH is not detected in the expected PSFCH resource, the UE may report the ACK to the higher layer.

For an unlicensed band, an Rx UE may need to perform sensing (e.g., listening) before transmitting a PSFCH transmission (e.g., talking). When the Rx UE fails to decode a PSSCH transmission and needs to transmit a NACK on a corresponding PSFCH resource, the Rx UE may fail to transmit the NACK on the corresponding PSFCH resource when an LBT is unsuccessful. Therefore, a Tx UE may fail to detect a PSFCH reception on a corresponding PSFCH occasion. For unicast PSSCH and groupcast option 2, the UE may report a NACK in response to an absence of a PSFCH transmission. However, for group cast option 1 (e.g., NACK-only feedback), an absence of a PSFCH reception may infer an ACK. Thus, the Tx UE may flush a HARQ buffer of associated sidelink processes and a retransmission of the PSSCH transmission may no longer be possible if a NACK is failed to be transmitted due to LBT failure for at least one Rx UE. The absence of the PSFCH reception may be due to the NACK failing due to the LBT failure, and not due to an ACK.

In various aspects of techniques and apparatuses described herein, a first UE may receive, from a second UE, a sidelink transmission associated with a cast type. The cast type may be unicast, groupcast option 1, or groupcast option 2. The first UE may transmit, to the second UE, HARQ feedback based at least in part on the sidelink transmission. Slots used for transmitting the HARQ feedback may be based at least in part on a set of HARQ timelines associated with the cast type. In other words, the first UE may determine the slots for transmitting the HARQ feedback based at least in part on the set of HARQ timelines corresponding to the cast type. The set of HARQ timelines may be included in multiple sets of HARQ timelines configured for sidelink. As a result, the multiple HARQ timelines may be (pre-)configured or specified for sidelink, where each set of HARQ timelines may be (pre-)configured or specified for a given cast type.

In some aspects, since LBT failure may be more detrimental for groupcast option 1, as opposed to unicast or groupcast option 2, an adaptive multiple opportunity for PSFCH based at least in part on the cast type may be employed. Adaptive multiple time domain opportunities for PSFCH based at least in part on the cast type may be employed. Further, adaptive multiple frequency domain opportunities for PSFCH may be employed.

FIG. 5 is a diagram illustrating an example 500 associated with transmitting feedback using slots based at least in part on a set of timelines, in accordance with the present disclosure. As shown in FIG. 5, example 500 includes communication between a first UE (e.g., UE 120a) and a second UE (e.g., UE 120e). In some aspects, the first UE and the second UE may be included in a wireless network, such as wireless network 100.

As shown by reference number 502, the first UE may receive, from the second UE, a sidelink transmission associated with a cast type. The first UE may receive the sidelink transmission via a sidelink channel between the first UE and the second UE. The cast type may be unicast, groupcast with NACK-only based HARQ feedback (e.g., groupcast option 1), or groupcast with ACK/NACK based HARQ feedback (e.g., groupcast option 2). In other words, the sidelink transmission may be associated with unicast, groupcast with NACK-only based HARQ feedback, or groupcast with ACK/NACK based HARQ feedback. The sidelink transmission may be associated with an unlicensed band (e.g., the sidelink transmission may be performed using a frequency within an unlicensed band).

As shown by reference number 504, the first UE may transmit, to the second UE, HARQ feedback based at least in part on the sidelink transmission. Slots used for transmitting the HARQ feedback may be based at least in part on a set of HARQ timelines associated with the cast type, where the set of HARQ timelines may be included in multiple sets of HARQ timelines configured for sidelink. The first UE may determine the slots for transmitting the HARQ feedback based at least in part on the set of HARQ timelines corresponding to the cast type.

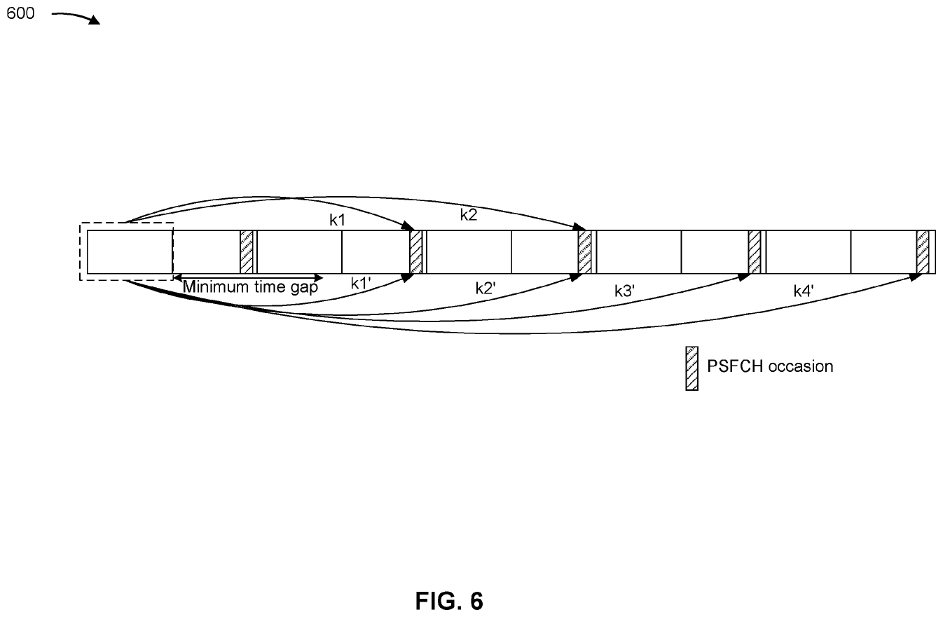

In some aspects, the multiple sets of HARQ timelines may be (pre-)configured or specified for sidelink, and each set may be (pre-)configured or specified for a given cast type, as shown by an example in FIG. 6. For the given cast type, the UE may determine the slots for a HARQ feedback transmission based at least in part on a set of HARQ timelines corresponding to the given cast type. For example, two sets of HARQ timelines may be specified, where a first set of HARQ timelines may include two HARQ timelines (k1, k2), and a second set of HARQ timelines may include four HARQ timelines (k1′, k2′, k3′, k4′). The first set of HARQ timelines may be for unicast/groupcast option 2, and the second set of HARQ timelines may be for groupcast option 1.

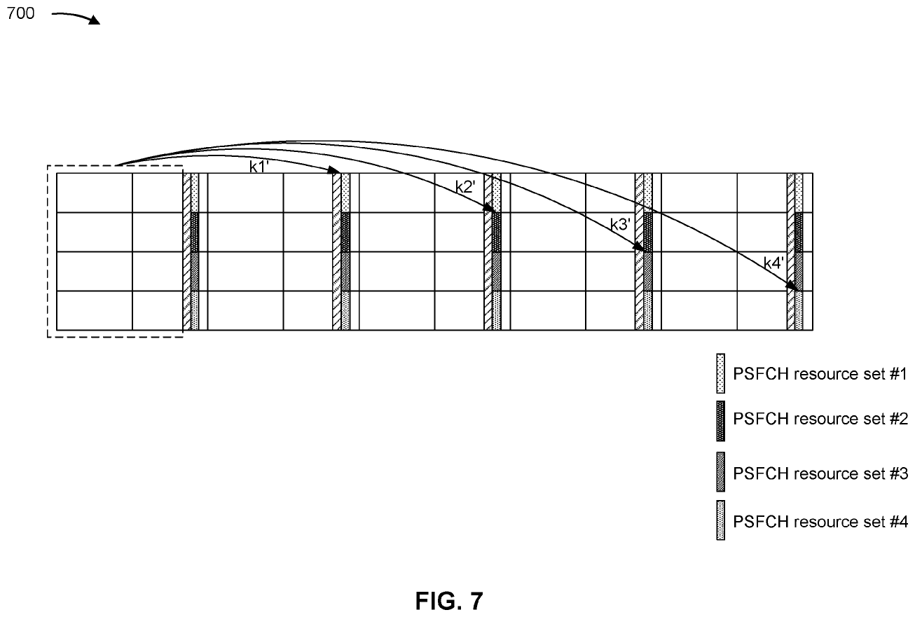

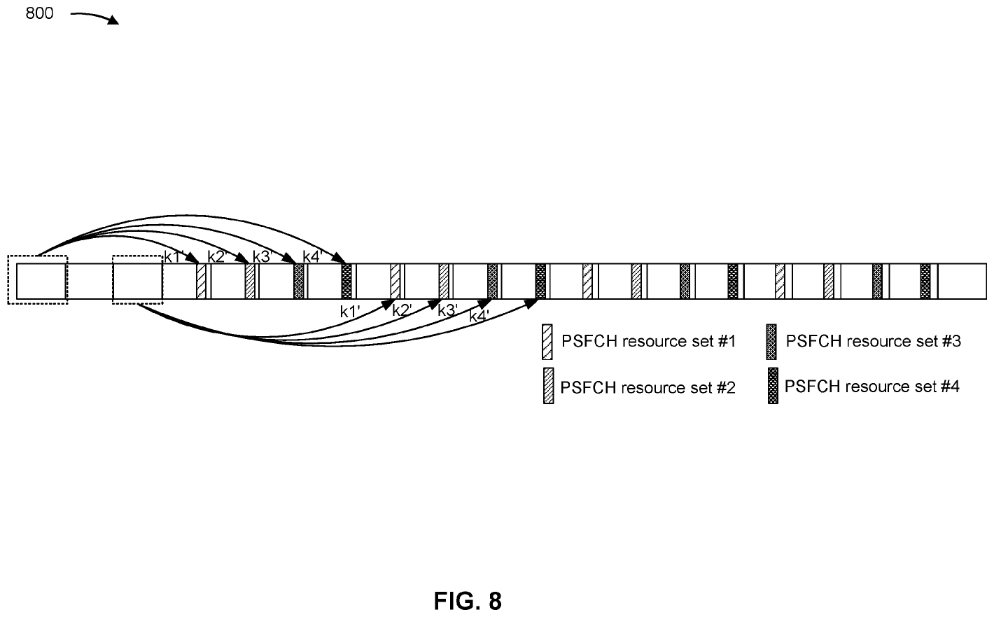

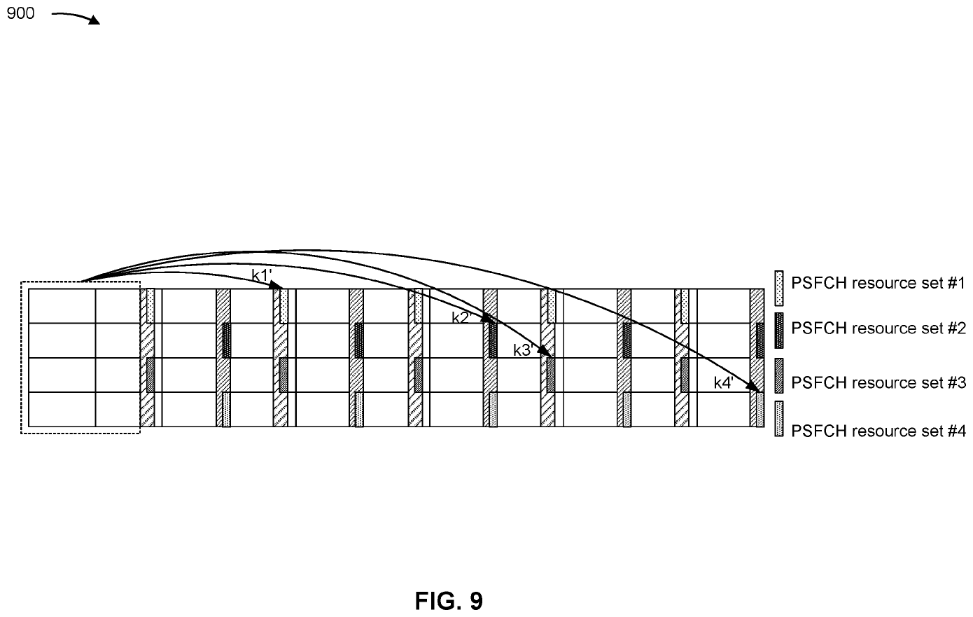

In some aspects, multiple PSFCH resource sets may be configured for HARQ feedback transmission based at least in part on HARQ timelines in a union set of the multiple sets of HARQ timelines, where each PSFCH resource set may have an associated HARQ timeline. Different PSFCH resource sets, of the multiple PSFCH resource sets, may be frequency division multiplexed, as shown by an example in FIG. 7. Different PSFCH resource sets, of the multiple PSFCH resource sets, may be time division multiplexed in different slots or symbols, as shown by an example in FIG. 8. Different PSFCH resource sets, of the multiple PSFCH resource sets, may be frequency division multiplexed and time division multiplexed, as shown by an example in FIG. 9.

In some aspects, the multiple sets of HARQ timelines may be enabled based at least in part on a HARQ feedback resource mapping. The multiple PSFCH resource sets may be (pre-)configured based at least in part on the HARQ timelines in the union set of the multiple sets of HARQ timelines. For example, two sets of HARQ timelines may be specified, where a first set of HARQ timelines may include two HARQ timelines (k1, k2), and a second set of HARQ timelines may include four timelines (k1′, k2′, k3′, k4′), where k1′=k1, k2′=k2, and then a union set of the first set and the second set may be (k1′,k2′,k3′,k4′). In this case, four PSFCH resource sets may be (pre-)configured for HARQ feedback transmissions, and each resource set may have an associated HARQ timeline.

In some aspects, a single PSFCH resource set may be configured for the multiple sets of HARQ timelines. A subset of PSFCH resources of the single PSFCH resource set may be determined based at least in part on a time domain location and a frequency domain location of the sidelink transmission. A HARQ feedback resource, of the subset of PSFCH resources, may be based at least in part on a first UE identifier, a second UE identifier, and a HARQ timeline index used for transmitting the HARQ feedback. The HARQ timeline index for the set of HARQ timelines, of the multiple sets of HARQ timelines, may be ordered in an increasing or decreasing order.

In some aspects, the single PSFCH resource set may be (pre-)configured for the multiple sets of HARQ timelines, but a HARQ feedback resource may be determined based at least in part on the HARQ timeline index. The HARQ timeline index may be ordered in an increasing/decreasing order of a HARQ timeline set. For example, two sets of HARQ timelines may be specified, where a first set of HARQ timelines may include two HARQ timelines (k1, k2), and a second set of HARQ timelines may include four timelines (k1′, k2′, k3′, k4′). Therefore, the HARQ timelines index may be m=0, 1, 2, 3, 4, 5, which may correspond to (k1, k2, k1′, k2′, k3′, k4′), respectively.

In some aspects, the UE may initially determine a subset of HARQ feedback resources (N_{PSFCH}⁽¹⁾) in a HARQ feedback resource set, which may be based at least in part on a PSSCH time and frequency location. The UE may then determine the HARQ feedback resource from the subset of HARQ feedback resources, which may be based at least in part on a Tx UE ID (P_{ID}), an Rx UE member ID (M_{ID}), and the HARQ timeline index used for a HARQ feedback transmission (m, m=0,1, . . . , M−1), where M is a defined integer. For example, (P_{ID}+M_{ID}+m)modN_{PSFCH}⁽¹⁾ (mod: modulo operator).

In some aspects, multiple PSFCH resource sets may be configured based at least in part on the multiple sets of HARQ timelines. A PSFCH resource set, of the multiple PSFCH resource sets, may be associated with the set of HARQ timelines. For each set of HARQ timelines, of the multiple sets of HARQ timelines, a subset of PSFCH resources in an associated PSFCH resource set may be determined based at least in part on a time domain location and a frequency domain location of the sidelink transmission. A HARQ feedback resource, of the subset of PSFCH resources, may be based at least in part on a HARQ timeline index in the set of HARQ timelines, a first UE identifier, and a second UE identifier.

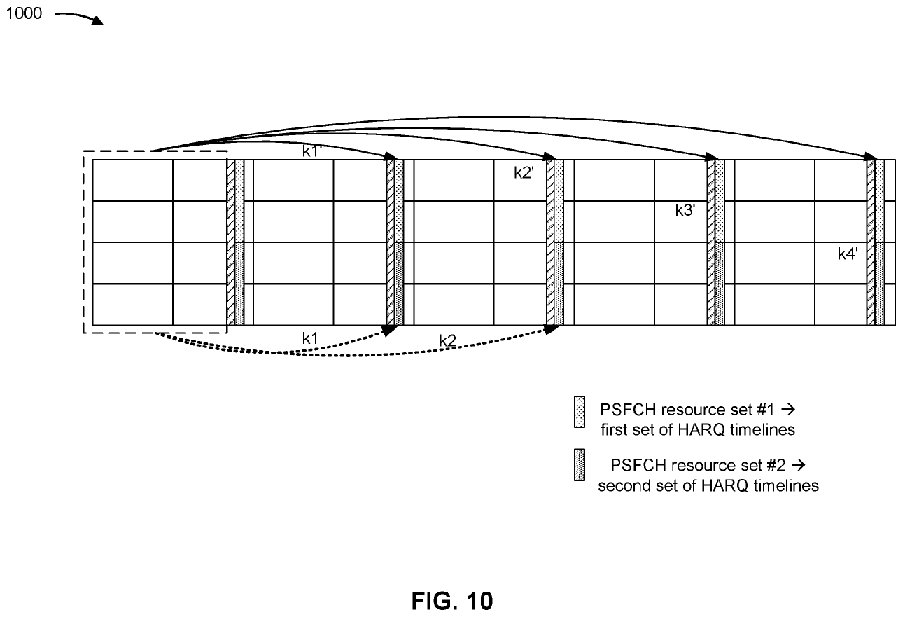

In some aspects, the multiple PSFCH resource sets may be (pre-)configured based at least in part on the multiple sets of HARQ timelines, where each PSFCH resource set may be associated with a set of HARQ timelines, as shown by an example in FIG. 10. Within each set of HARQ timelines, the HARQ feedback resource may be determined based at least in part on an index of HARQ timelines in the set. Different PSFCH resource sets may be frequency division multiplexed and/or time division multiplexed. For example, two sets of HARQ timelines may be specified, where a first set of HARQ timelines may include two HARQ timelines (k1, k2), and a second set of HARQ timelines may include four timelines (k1′, k2′, k3′, k4′). In this case, two PSFCH resource sets may be (pre-)configured for HARQ feedback transmission, and each PSFCH resource set may be associated with a set of HARQ timelines.

In some aspects, for a first set of HARQ timelines, M₁ HARQ timelines may be specified or configured, and for a second set of HARQ timelines, M₂ HARQ timelines may be specified or configured. The UE may first determine a subset of HARQ feedback resources in each PSFCH resource set, which may be based at least in part on a PSSCH time and frequency location. For example, a first subset of HARQ feedback resources may include N_{PSFCH}⁽¹⁾ HARQ feedback resources in a first PSFCH resource set, and a second subset of HARQ feedback resources may include N_{PSFCH}⁽²⁾ HARQ feedback resources in a second PSFCH resource set. The UE may then determine a HARQ feedback resource from each subset of HARQ feedback resources based at least in part on a Tx UE ID (PD_{ID}), an Rx UE member ID (M_{ID}), and a HARQ timeline index used for a HARQ feedback transmission in a corresponding set of HARQ timelines. A first HARQ feedback resource may be determined based at least in part on (PD_{ID}+M_{ID}+m)modN_{PSFCH}⁽¹⁾, Where m=0, 1, . . . , M₁−1. A second HARQ feedback resource may be determined based at least in part on (PD_{ID}+M_{ID}+m)modN_{PSFCH}⁽²⁾, where m=0, 1, . . . , M₂−1.

As indicated above, FIG. 5 is provided as an example. Other examples may differ from what is described with regard to FIG. 5.

FIG. 6 is a diagram illustrating an example 600 associated with transmitting feedback using slots based at least in part on a set of timelines, in accordance with the present disclosure.

As shown in FIG. 6, two sets of HARQ timelines may be specified. A first set of HARQ timelines may include two HARQ timelines (k1, k2). The two HARQ timelines may be associated with two PSFCH occasions. The first set of HARQ timelines may be for unicast or groupcast option 2. A second set of HARQ timelines may include four HARQ timelines (k1′, k2′, k3′, k4′). The second set of HARQ timelines may be for groupcast option 1. The four HARQ timelines may be associated with four PSFCH occasions, which may partially overlap with the two PSFCH occasions associated with the first set of HARQ timelines.

As indicated above, FIG. 6 is provided as an example. Other examples may differ from what is described with regard to FIG. 6.

FIG. 7 is a diagram illustrating an example 700 associated with transmitting feedback using slots based at least in part on a set of timelines, in accordance with the present disclosure.

As shown in FIG. 7, different PSFCH resource sets may be frequency division multiplexed. The different PSFCH resource sets may include a first PSFCH resource set, a second PSFCH resource set, a third PSFCH resource set, and a fourth PSFCH resource set. Each of the first PSFCH resource set, the second PSFCH resource set, the third PSFCH resource set, and the fourth PSFCH resource set may be associated with a HARQ timeline. For example, the first PSFCH resource set may be associated with a first HARQ timeline (k1′), the second PSFCH resource set may be associated with a second HARQ timeline (k2′), the third PSFCH resource set may be associated with a third HARQ timeline (k3′), and the fourth PSFCH resource set may be associated with a fourth HARQ timeline (k4′).

As indicated above, FIG. 7 is provided as an example. Other examples may differ from what is described with regard to FIG. 7.

FIG. 8 is a diagram illustrating an example 800 associated with transmitting feedback using slots based at least in part on a set of timelines, in accordance with the present disclosure.

As shown in FIG. 8, different PSFCH resource sets may be time division multiplexed on different slots/symbols. The different PSFCH resource sets may include a first PSFCH resource set, a second PSFCH resource set, a third PSFCH resource set, and a fourth PSFCH resource set, and each PSFCH resource set may have an associated HARQ timeline.

As indicated above, FIG. 8 is provided as an example. Other examples may differ from what is described with regard to FIG. 8.

FIG. 9 is a diagram illustrating an example 900 associated with transmitting feedback using slots based at least in part on a set of timelines, in accordance with the present disclosure.

As shown in FIG. 9, different PSFCH resource sets may be frequency division multiplexed and time division multiplexed. The different PSFCH resource sets may include a first PSFCH resource set, a second PSFCH resource set, a third PSFCH resource set, and a fourth PSFCH resource set, and each PSFCH resource set may have an associated HARQ timeline.

As indicated above, FIG. 9 is provided as an example. Other examples may differ from what is described with regard to FIG. 9.

FIG. 10 is a diagram illustrating an example 1000 associated with transmitting feedback using slots based at least in part on a set of timelines, in accordance with the present disclosure.

As shown in FIG. 10, different PSFCH resource sets may be frequency division multiplexed, where each PSFCH resource set may be associated with a set of HARQ timelines. For example, a first PSFCH resource set may be associated with a first set of HARQ timelines, and a second PSFCH resource set may be associated with a second set of HARQ timelines. The first set of HARQ timelines may include four timelines (k1′, k2′, k3′, k4′), and the second set of HARQ timelines may include two timelines (k1, k2).

As indicated above, FIG. 10 is provided as an example. Other examples may differ from what is described with regard to FIG. 10.

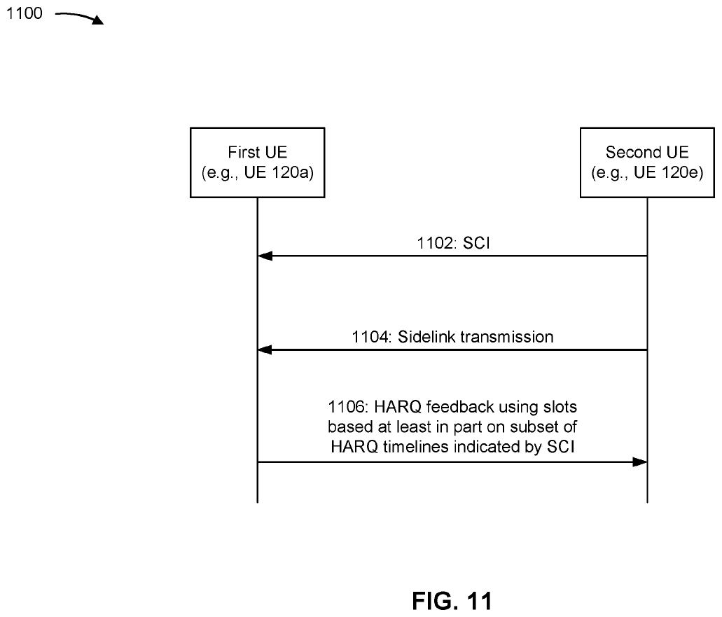

FIG. 11 is a diagram illustrating an example 1100 associated with transmitting feedback using slots based at least in part on a set of timelines, in accordance with the present disclosure. As shown in FIG. 11, example 1100 includes communication between a first UE (e.g., UE 120a) and a second UE (e.g., UE 120e). In some aspects, the first UE and the second UE may be included in a wireless network, such as wireless network 100.

As shown by reference number 1102, the first UE may receive, from the second UE, SCI. The SCI may carry information associated with a sidelink transmission. The SCI may indicate a subset of HARQ timelines, where the subset of HARQ timelines may be included in multiple HARQ timelines configured for sidelink.

As shown by reference number 1104, the first UE may receive, from the second UE, the sidelink transmission. The first UE may receive the sidelink transmission based at least in part on the SCI. The first UE may receive the sidelink transmission via a sidelink channel between the first UE and the second UE. The sidelink transmission may be associated with an unlicensed band.

As shown by reference number 1106, the first UE may transmit, to the second UE, HARQ feedback based at least in part on the sidelink transmission. Slots used for transmitting the HARQ feedback may be based at least in part on the subset of HARQ timelines indicated by the SCI, where the subset of HARQ timelines may be included in the multiple HARQ timelines configured for sidelink. The SCI may indicate a quantity of HARQ timelines associated with the subset of HARQ timelines, where the quantity of HARQ timelines among the multiple HARQ timelines may be used for transmitting the HARQ feedback. The SCI may indicate multiple HARQ timeline codepoints, and a HARQ timeline codepoint, of the multiple HARQ timeline codepoints, may indicate the subset of HARQ timelines.

In some aspects, the multiple HARQ timelines may be (pre-)configured or specified for sidelink, and the subset of HARQ timelines may be indicated by the SCI. In a first approach, a quantity of HARQ timelines may be indicated by the SCI, and first multiple HARQ timelines may be used. For example, four HARQ timelines (k1, k2, k3, k4) may be configured, and a quantity of HARQ timelines indicated by SCI may be N, in which case the first N HARQ timelines among the four HARQ timelines may be used for HARQ feedback. In a second approach, multiple HARQ timeline codepoints may be indicated by SCI, and each HARQ timeline codepoint may indicate one or more HARQ timelines. For example, four HARQ timelines may be configured, in which case up to C₄¹+C₄²+C₄³+C₄⁴=15 codepoints may be indicated, where each codepoint may indicate one or more HARQ timelines.

In some aspects, in the first approach, the quantity of HARQ timelines may be indicated by SCI. For an index of “0”, a quantity of HARQ timelines may be one, which may correspond to a first HARQ timeline (k1). For an index of “1”, a quantity of HARQ timelines may be two, which may correspond to first and second HARQ timelines (k1, k2). For an index of “2”, a quantity of HARQ timelines may be three, which may correspond to first, second, and third HARQ timelines (k1, k2, k3). For an index of “3”, a quantity of HARQ timelines may be four, which may correspond to first, second, third, and fourth HARQ timelines (k1, k2, k3, k4).

In some aspects, in the second approach, the multiple HARQ timeline codepoints may be indicated by SCI. A codepoint of “0000” may correspond to a HARQ timeline of (k1), a codepoint of “0001” may correspond to a HARQ timeline of (k2), a codepoint of “0010” may correspond to a HARQ timeline of (k3), a codepoint of “0011” may correspond to a HARQ timeline of (k4), a codepoint of “0100” may correspond to HARQ timelines of (k1, k2), a codepoint of “0101” may correspond to HARQ timelines of (k1, k3), a codepoint of “0110” may correspond to HARQ timelines of (k1, k4), a codepoint of “0111” may correspond to HARQ timelines of (k2, k3), a codepoint of “0100” may correspond to HARQ timelines of (k2, k4), a codepoint of “1001” may correspond to HARQ timelines of (k3, k4), a codepoint of “1010” may correspond to HARQ timelines of (k1, k2, k3), a codepoint of “1011” may correspond to HARQ timelines of (k1, k2, k4), a codepoint of “1100” may correspond to HARQ timelines of (k1, k3, k4), a codepoint of “1101” may correspond to HARQ timelines of (k2, k3, k4), a codepoint of “1100” may correspond to HARQ timelines of (k1, k2, k3, k4), and a codepoint of “1111” may be reserved.

As indicated above, FIG. 11 is provided as an example. Other examples may differ from what is described with regard to FIG. 11.

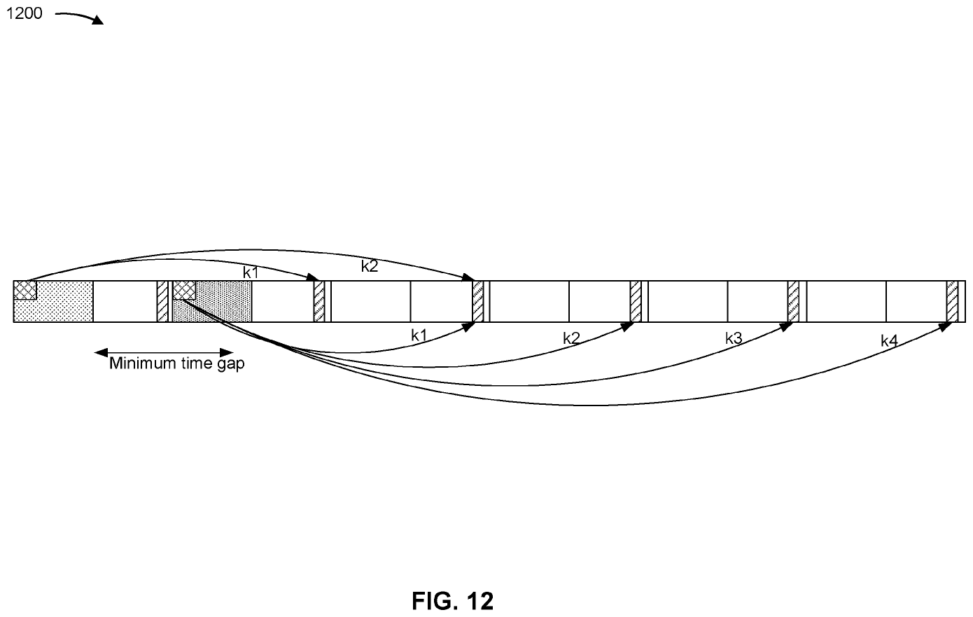

FIG. 12 is a diagram illustrating an example 1200 associated with transmitting feedback using slots based at least in part on a set of timelines, in accordance with the present disclosure.

As shown in FIG. 12, a first SCI may indicate two HARQ timelines (k1, k2). The two HARQ timelines may correspond to two time domain opportunities. A second SCI may indicate four HARQ timelines (k1, k2, k3, k4). The four HARQ timelines may correspond to four time domain opportunities. The two HARQ timelines and the four HARQ timelines may be indicated, via SCIs, from multiple HARQ timelines that are (pre-)configured or specified for sidelink.

As indicated above, FIG. 12 is provided as an example. Other examples may differ from what is described with regard to FIG. 12.

FIG. 13 is a diagram illustrating an example process 1300 performed, for example, by a first UE, in accordance with the present disclosure. Example process 1300 is an example where the first UE (e.g., UE 120a) performs operations associated with transmitting feedback using slots based at least in part on a set of timelines.

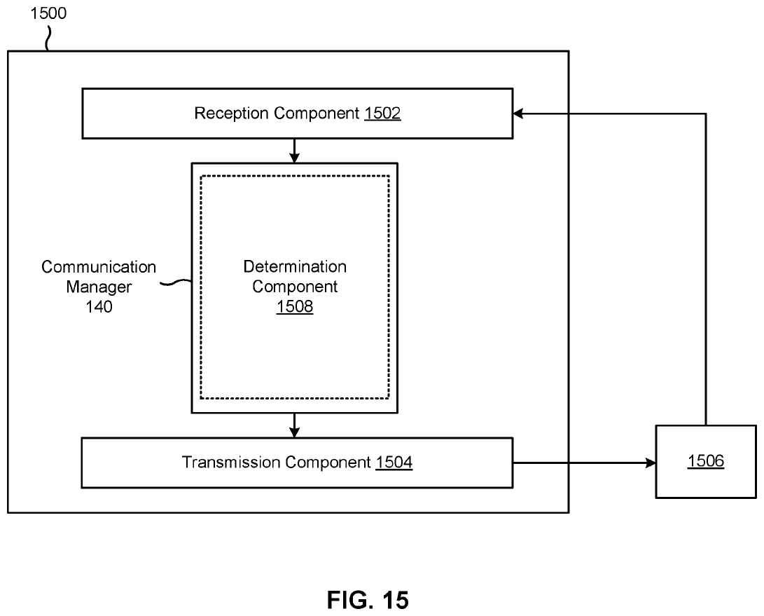

As shown in FIG. 13, in some aspects, process 1300 may include receiving, from a second UE, a sidelink transmission associated with a cast type (block 1310). For example, the first UE (e.g., using communication manager 140 and/or reception component 1502, depicted in FIG. 15) may receive, from a second UE, a sidelink transmission associated with a cast type, as described above.

As further shown in FIG. 13, in some aspects, process 1300 may include transmitting, to the second UE, HARQ feedback based at least in part on the sidelink transmission, wherein slots used for transmitting the HARQ feedback are based at least in part on a set of HARQ timelines associated with the cast type, and wherein the set of HARQ timelines is included in multiple sets of HARQ timelines configured for sidelink (block 1320). For example, the first UE (e.g., using communication manager 140 and/or transmission component 1504, depicted in FIG. 15) may transmit, to the second UE, HARQ feedback based at least in part on the sidelink transmission, wherein slots used for transmitting the HARQ feedback are based at least in part on a set of HARQ timelines associated with the cast type, and wherein the set of HARQ timelines is included in multiple sets of HARQ timelines configured for sidelink, as described above.

Process 1300 may include additional aspects, such as any single aspect or any combination of aspects described below and/or in connection with one or more other processes described elsewhere herein.

In a first aspect, process 1300 includes determining the slots for transmitting the HARQ feedback based at least in part on the set of HARQ timelines corresponding to the cast type.

In a second aspect, alone or in combination with the first aspect, the cast type is one of unicast, groupcast with NACK-only based HARQ feedback, or groupcast with ACK/NACK based HARQ feedback.

In a third aspect, alone or in combination with one or more of the first and second aspects, multiple PSFCH resource sets are configured for HARQ feedback transmission based at least in part on HARQ timelines in a union set of the multiple sets of HARQ timelines, and each PSFCH resource set has an associated HARQ timeline.

In a fourth aspect, alone or in combination with one or more of the first through third aspects, different PSFCH resource sets, of the multiple PSFCH resource sets, are frequency division multiplexed.

In a fifth aspect, alone or in combination with one or more of the first through fourth aspects, different PSFCH resource sets, of the multiple PSFCH resource sets, are time division multiplexed in different slots or symbols.

In a sixth aspect, alone or in combination with one or more of the first through fifth aspects, different PSFCH resource sets, of the multiple PSFCH resource sets, are frequency division multiplexed and time division multiplexed.

In a seventh aspect, alone or in combination with one or more of the first through sixth aspects, a single PSFCH resource set is configured for the multiple sets of HARQ timelines; a subset of PSFCH resources of the single PSFCH resource set is determined based at least in part on a time domain location and a frequency domain location of the sidelink transmission, and a HARQ feedback resource, of the subset of PSFCH resources, is based at least in part on a first UE identifier, a second UE identifier, and a HARQ timeline index used for transmitting the HARQ feedback; and the HARQ timeline index for the set of HARQ timelines, of the multiple sets of HARQ timelines, is ordered in an increasing or decreasing order.

In an eighth aspect, alone or in combination with one or more of the first through seventh aspects, multiple PSFCH resource sets are configured based at least in part on the multiple sets of HARQ timelines, and a PSFCH resource set, of the multiple PSFCH resource sets, is associated with the set of HARQ timelines.

In a ninth aspect, alone or in combination with one or more of the first through eighth aspects, for each set of HARQ timelines, of the multiple sets of HARQ timelines, a subset of PSFCH resources in an associated PSFCH resource set is determined based at least in part on a time domain location and a frequency domain location of the sidelink transmission, and a HARQ feedback resource, of the subset of PSFCH resources, is based at least in part on a HARQ timeline index in the set of HARQ timelines, a first UE identifier, and a second UE identifier.

In a tenth aspect, alone or in combination with one or more of the first through ninth aspects, the sidelink transmission is associated with an unlicensed band.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a first UE, in accordance with the present disclosure. Example process 1400 is an example where the first UE (e.g., UE 120) performs operations associated with transmitting feedback using slots based at least in part on a set of timelines.

As shown in FIG. 14, in some aspects, process 1400 may include receiving, from a second UE, SCI (block 1410). For example, the first UE (e.g., using communication manager 140 and/or reception component 1502, depicted in FIG. 15) may receive, from a second UE, SCI, as described above.

As further shown in FIG. 14, in some aspects, process 1400 may include receiving, from the second UE, a sidelink transmission (block 1420). For example, the first UE (e.g., using communication manager 140 and/or reception component 1502, depicted in FIG. 15) may receive, from the second UE, a sidelink transmission, as described above.

As further shown in FIG. 14, in some aspects, process 1400 may include transmitting, to the second UE, HARQ feedback based at least in part on the sidelink transmission, wherein slots used for transmitting the HARQ feedback are based at least in part on a subset of HARQ timelines indicated by the SCI, and wherein the subset of HARQ timelines is included in multiple HARQ timelines configured for sidelink (block 1430). For example, the first UE (e.g., using communication manager 140 and/or transmission component 1504, depicted in FIG. 15) may transmit, to the second UE, HARQ feedback based at least in part on the sidelink transmission, wherein slots used for transmitting the HARQ feedback are based at least in part on a subset of HARQ timelines indicated by the SCI, and wherein the subset of HARQ timelines is included in multiple HARQ timelines configured for sidelink, as described above.

Process 1400 may include additional aspects, such as any single aspect or any combination of aspects described below and/or in connection with one or more other processes described elsewhere herein.

In a first aspect, the SCI indicates a quantity of HARQ timelines associated with the subset of HARQ timelines, and the quantity of HARQ timelines among the multiple HARQ timelines is used for transmitting the HARQ feedback.

In a second aspect, alone or in combination with the first aspect, the SCI indicates multiple HARQ timeline codepoints, and a HARQ timeline codepoint, of the multiple HARQ timeline codepoints, indicates the subset of HARQ timelines.

In a third aspect, alone or in combination with one or more of the first and second aspects, the sidelink transmission is associated with an unlicensed band.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication. The apparatus 1500 may be a first UE, or a first UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 140. The communication manager 140 may include a determination component 1508, among other examples.

In some aspects, the apparatus 1500 may be configured to perform one or more operations described herein in connection with FIGS. 5-12. Additionally, or alternatively, the apparatus 1500 may be configured to perform one or more processes described herein, such as process 1300 of FIG. 13, process 1400 of FIG. 14, or a combination thereof. In some aspects, the apparatus 1500 and/or one or more components shown in FIG. 15 may include one or more components of the first UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the first UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the first UE described in connection with FIG. 2. In some aspects, the transmission component 1504 may be co-located with the reception component 1502 in a transceiver.

The reception component 1502 may receive, from a second UE, a sidelink transmission associated with a cast type. The transmission component 1504 may transmit, to the second UE, HARQ feedback based at least in part on the sidelink transmission, wherein slots used for transmitting the HARQ feedback are based at least in part on a set of HARQ timelines associated with the cast type, and wherein the set of HARQ timelines is included in multiple sets of HARQ timelines configured for sidelink. The determination component 1508 may determine the slots for transmitting the HARQ feedback based at least in part on the set of HARQ timelines corresponding to the cast type.

The reception component 1502 may receive, from a second UE, SCI. The reception component 1502 may receive, from the second UE, a sidelink transmission. The transmission component 1504 may transmit, to the second UE, HARQ feedback based at least in part on the sidelink transmission, wherein slots used for transmitting the HARQ feedback are based at least in part on a subset of HARQ timelines indicated by the SCI, and wherein the subset of HARQ timelines is included in multiple HARQ timelines configured for sidelink.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a first user equipment (UE), comprising: receiving, from a second UE, a sidelink transmission associated with a cast type; and transmitting, to the second UE, hybrid automatic repeat request (HARQ) feedback based at least in part on the sidelink transmission, wherein slots used for transmitting the HARQ feedback are based at least in part on a set of HARQ timelines associated with the cast type, and wherein the set of HARQ timelines is included in multiple sets of HARQ timelines configured for sidelink.

Aspect 2: The method of Aspect 1, further comprising: determining the slots for transmitting the HARQ feedback based at least in part on the set of HARQ timelines corresponding to the cast type.

Aspect 3: The method of any of Aspects 1 through 2, wherein the cast type is one of: unicast, groupcast with negative acknowledgement (NACK)-only based HARQ feedback, or groupcast with acknowledgement or NACK based HARQ feedback.

Aspect 4: The method of any of Aspects 1 through 3, wherein multiple physical sidelink feedback channel (PSFCH) resource sets are configured for HARQ feedback transmission based at least in part on HARQ timelines in a union set of the multiple sets of HARQ timelines, and wherein each PSFCH resource set has an associated HARQ timeline.

Aspect 5: The method of Aspect 4, wherein different PSFCH resource sets, of the multiple PSFCH resource sets, are frequency division multiplexed.

Aspect 6: The method of Aspect 4, wherein different PSFCH resource sets, of the multiple PSFCH resource sets, are time division multiplexed in different slots or symbols.

Aspect 7: The method of Aspect 4, wherein different PSFCH resource sets, of the multiple PSFCH resource sets, are frequency division multiplexed and time division multiplexed.

Aspect 8: The method of any of Aspects 1 through 7, wherein a single physical sidelink feedback channel (PSFCH) resource set is configured for the multiple sets of HARQ timelines; a subset of PSFCH resources of the single PSFCH resource set is determined based at least in part on a time domain location and a frequency domain location of the sidelink transmission, and a HARQ feedback resource, of the subset of PSFCH resources, is based at least in part on a first UE identifier, a second UE identifier, and a HARQ timeline index used for transmitting the HARQ feedback; and the HARQ timeline index for the set of HARQ timelines, of the multiple sets of HARQ timelines, is ordered in an increasing or decreasing order.

Aspect 9: The method of any of Aspects 1 through 8, wherein multiple physical sidelink feedback channel (PSFCH) resource sets are configured based at least in part on the multiple sets of HARQ timelines, and a PSFCH resource set, of the multiple PSFCH resource sets, is associated with the set of HARQ timelines.

Aspect 10: The method of Aspect 9, wherein for each set of HARQ timelines, of the multiple sets of HARQ timelines, a subset of PSFCH resources in an associated PSFCH resource set is determined based at least in part on a time domain location and a frequency domain location of the sidelink transmission, and a HARQ feedback resource, of the subset of PSFCH resources, is based at least in part on a HARQ timeline index in the set of HARQ timelines, a first UE identifier, and a second UE identifier.

Aspect 11: The method of any of Aspects 1 through 10, wherein the sidelink transmission is associated with an unlicensed band.

Aspect 12: A method of wireless communication performed by a first user equipment (UE), comprising: receiving, from a second UE, sidelink control information (SCI); receiving, from the second UE, a sidelink transmission; and transmitting, to the second UE, hybrid automatic repeat request (HARQ) feedback based at least in part on the sidelink transmission, wherein slots used for transmitting the HARQ feedback are based at least in part on a subset of HARQ timelines indicated by the SCI, and wherein the subset of HARQ timelines is included in multiple HARQ timelines configured for sidelink.

Aspect 13: The method of Aspect 12, wherein the SCI indicates a quantity of HARQ timelines associated with the subset of HARQ timelines, and wherein the quantity of HARQ timelines among the multiple HARQ timelines is used for transmitting the HARQ feedback.

Aspect 14: The method of any of Aspects 12 through 13, wherein the SCI indicates multiple HARQ timeline codepoints, and a HARQ timeline codepoint, of the multiple HARQ timeline codepoints, indicates the subset of HARQ timelines.

Aspect 15: The method of any of Aspects 12 through 14, wherein the sidelink transmission is associated with an unlicensed band.

Aspect 16: An apparatus for wireless communication at a device, comprising a processor; memory coupled with the processor; and instructions stored in the memory and executable by the processor to cause the apparatus to perform the method of one or more of Aspects 1-15.

Aspect 17: A device for wireless communication, comprising a memory and one or more processors coupled to the memory, the one or more processors configured to perform the method of one or more of Aspects 1-15.

Aspect 18: An apparatus for wireless communication, comprising at least one means for performing the method of one or more of Aspects 1-15.

Aspect 19: A non-transitory computer-readable medium storing code for wireless communication, the code comprising instructions executable by a processor to perform the method of one or more of Aspects 1-15.

Aspect 20: A non-transitory computer-readable medium storing a set of instructions for wireless communication, the set of instructions comprising one or more instructions that, when executed by one or more processors of a device, cause the device to perform the method of one or more of Aspects 1-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a first user equipment (UE), comprising:
a memory; and
one or more processors, coupled to the memory, configured to:
receive, from a second UE, a sidelink transmission associated with a cast type; and
transmit, to the second UE, hybrid automatic repeat request (HARQ) feedback based at least in part on the sidelink transmission, wherein slots used for transmitting the HARQ feedback are based at least in part on a set of HARQ timelines associated with the cast type, and wherein the set of HARQ timelines is included in multiple sets of HARQ timelines configured for sidelink.

2. The apparatus of claim 1, wherein the one or more processors are further configured to:
determine the slots for transmitting the HARQ feedback based at least in part on the set of HARQ timelines corresponding to the cast type.

3. The apparatus of claim 1, wherein the cast type is one of: unicast, groupcast with negative acknowledgement (NACK)-only based HARQ feedback, or groupcast with acknowledgement or NACK based HARQ feedback.

4. The apparatus of claim 1, wherein multiple physical sidelink feedback channel (PSFCH) resource sets are configured for HARQ feedback transmission based at least in part on HARQ timelines in a union set of the multiple sets of HARQ timelines, and wherein each PSFCH resource set has an associated HARQ timeline.

5. The apparatus of claim 4, wherein different PSFCH resource sets, of the multiple PSFCH resource sets, are frequency division multiplexed.

6. The apparatus of claim 4, wherein different PSFCH resource sets, of the multiple PSFCH resource sets, are time division multiplexed in different slots or symbols.

7. The apparatus of claim 4, wherein different PSFCH resource sets, of the multiple PSFCH resource sets, are frequency division multiplexed and time division multiplexed.

8. The apparatus of claim 1, wherein:
a single physical sidelink feedback channel (PSFCH) resource set is configured for the multiple sets of HARQ timelines;
a subset of PSFCH resources of the single PSFCH resource set is determined based at least in part on a time domain location and a frequency domain location of the sidelink transmission, and a HARQ feedback resource, of the subset of PSFCH resources, is based at least in part on a first UE identifier, a second UE identifier, and a HARQ timeline index used for transmitting the HARQ feedback; and
the HARQ timeline index for the set of HARQ timelines, of the multiple sets of HARQ timelines, is ordered in an increasing or decreasing order.

9. The apparatus of claim 1, wherein multiple physical sidelink feedback channel (PSFCH) resource sets are configured based at least in part on the multiple sets of HARQ timelines, and a PSFCH resource set, of the multiple PSFCH resource sets, is associated with the set of HARQ timelines.

10. The apparatus of claim 9, wherein for each set of HARQ timelines, of the multiple sets of HARQ timelines, a subset of PSFCH resources in an associated PSFCH resource set is determined based at least in part on a time domain location and a frequency domain location of the sidelink transmission, and a HARQ feedback resource, of the subset of PSFCH resources, is based at least in part on a HARQ timeline index in the set of HARQ timelines, a first UE identifier, and a second UE identifier.

11. The apparatus of claim 1, wherein the sidelink transmission is associated with an unlicensed band.

12. An apparatus for wireless communication at a first user equipment (UE), comprising:
a memory; and
one or more processors, coupled to the memory, configured to:
receive, from a second UE, sidelink control information (SCI);
receive, from the second UE, a sidelink transmission; and
transmit, to the second UE, hybrid automatic repeat request (HARQ) feedback based at least in part on the sidelink transmission, wherein slots used for transmitting the HARQ feedback are based at least in part on a subset of HARQ timelines indicated by the SCI, and wherein the subset of HARQ timelines is included in multiple HARQ timelines configured for sidelink.

13. The apparatus of claim 12, wherein the SCI indicates a quantity of HARQ timelines associated with the subset of HARQ timelines, and wherein the quantity of HARQ timelines among the multiple HARQ timelines is used for transmitting the HARQ feedback.

14. The apparatus of claim 12, wherein the SCI indicates multiple HARQ timeline codepoints, and a HARQ timeline codepoint, of the multiple HARQ timeline codepoints, indicates the subset of HARQ timelines.

15. The apparatus of claim 12, wherein the sidelink transmission is associated with an unlicensed band.

16. A method of wireless communication performed by a first user equipment (UE), comprising:
receiving, from a second UE, a sidelink transmission associated with a cast type; and
transmitting, to the second UE, hybrid automatic repeat request (HARQ) feedback based at least in part on the sidelink transmission, wherein slots used for transmitting the HARQ feedback are based at least in part on a set of HARQ timelines associated with the cast type, and wherein the set of HARQ timelines is included in multiple sets of HARQ timelines configured for sidelink.

17. The method of claim 16, further comprising:
determining the slots for transmitting the HARQ feedback based at least in part on the set of HARQ timelines corresponding to the cast type.

18. The method of claim 16, wherein the cast type is one of: unicast, groupcast with negative acknowledgement (NACK)-only based HARQ feedback, or groupcast with acknowledgement or NACK based HARQ feedback.

19. The method of claim 16, wherein multiple physical sidelink feedback channel (PSFCH) resource sets are configured for HARQ feedback transmission based at least in part on HARQ timelines in a union set of the multiple sets of HARQ timelines, and wherein each PSFCH resource set has an associated HARQ timeline.

20. The method of claim 19, wherein different PSFCH resource sets, of the multiple PSFCH resource sets, are frequency division multiplexed.

21. The method of claim 19, wherein different PSFCH resource sets, of the multiple PSFCH resource sets, are time division multiplexed in different slots or symbols.

22. The method of claim 19, wherein different PSFCH resource sets, of the multiple PSFCH resource sets, are frequency division multiplexed and time division multiplexed.

23. The method of claim 16, wherein:
a single physical sidelink feedback channel (PSFCH) resource set is configured for the multiple sets of HARQ timelines;
a subset of PSFCH resources of the single PSFCH resource set is determined based at least in part on a time domain location and a frequency domain location of the sidelink transmission, and a HARQ feedback resource, of the subset of PSFCH resources, is based at least in part on a first UE identifier, a second UE identifier, and a HARQ timeline index used for transmitting the HARQ feedback; and
the HARQ timeline index for the set of HARQ timelines, of the multiple sets of HARQ timelines, is ordered in an increasing or decreasing order.

24. The method of claim 16, wherein multiple physical sidelink feedback channel (PSFCH) resource sets are configured based at least in part on the multiple sets of HARQ timelines, and a PSFCH resource set, of the multiple PSFCH resource sets, is associated with the set of HARQ timelines.

25. The method of claim 24, wherein for each set of HARQ timelines, of the multiple sets of HARQ timelines, a subset of PSFCH resources in an associated PSFCH resource set is determined based at least in part on a time domain location and a frequency domain location of the sidelink transmission, and a HARQ feedback resource, of the subset of PSFCH resources, is based at least in part on a HARQ timeline index in the set of HARQ timelines, a first UE identifier, and a second UE identifier.

26. The method of claim 16, wherein the sidelink transmission is associated with an unlicensed band.

27. A method of wireless communication performed by a first user equipment (UE), comprising:
receiving, from a second UE, sidelink control information (SCI);
receiving, from the second UE, a sidelink transmission; and
transmitting, to the second UE, hybrid automatic repeat request (HARQ) feedback based at least in part on the sidelink transmission, wherein slots used for transmitting the HARQ feedback are based at least in part on a subset of HARQ timelines indicated by the SCI, and wherein the subset of HARQ timelines is included in multiple HARQ timelines configured for sidelink.

28. The method of claim 27, wherein the SCI indicates a quantity of HARQ timelines associated with the subset of HARQ timelines, and wherein the quantity of HARQ timelines among the multiple HARQ timelines is used for transmitting the HARQ feedback.

29. The method of claim 27, wherein the SCI indicates multiple HARQ timeline codepoints, and a HARQ timeline codepoint, of the multiple HARQ timeline codepoints, indicates the subset of HARQ timelines.

30. The method of claim 27, wherein the sidelink transmission is associated with an unlicensed band.
